(19) United States
(12) Patent Application Publication
(10) Pub. No.: US 2007/0211451 A1
(43) Pub. Date: Sep. 13, 2007

(54) Indoor shoe with illuminant function

(76) Inventor: Hsiao Chieh Chung, Kaohsiung City (TW)

Correspondence Address: BACON & THOMAS, PLLC, 625 SLATERS LANE, FOURTH FLOOR, ALEXANDRIA, VA, 22314, US

(21) Appl. No.: 11/451,359

(22) Filed: Jun. 13, 2006

(30) Foreign Application Priority Data
Mar. 8, 2006 (TW) 095203869

(51) Int. Cl. F21V 21/08

(52) U.S. Cl. 362/103

(57) ABSTRACT

An indoor shoe with an illumination capability, and the indoor shoe has a shoe body, a light source, a triggering device, and a battery. The triggering device is electrically connected to the battery and the light source, and the triggering device is a pressure sensitive triggering device; wherein when a user steps on the bottom portion, the triggering device switches on the light source.

### BACKGROUND OF THE INVENTION

1. Field of the Invention

The present invention relates to an indoor shoe with an illumination capability, and, more particularly, to an indoor shoe with an illumination capability to provide nighttime illumination.

2. Description of the Related Art

Recently, there have been many shoe designs utilizing illumination devices for entertainment purposes, predominantly for children's shoes. Related U.S. patents (such as U.S. Pat. Nos. 5,033,212 and 5,692,324) disclose a light source in the design of the shoe, which designs are all for decoration or illumination effects in outdoor shoes (such as disclosed in U.S. Pat. No. 5,329,432), and not for indoor shoes. However, for many people it is very inconvenient to find a light switch in the middle of the night, and this is especially true for the elderly; moreover, turning on the light may disturb other people in the room.

Therefore, it is desirable to provide an indoor shoe with illumination capabilities to mitigate and/or obviate the aforementioned problems.

### SUMMARY OF THE INVENTION

A main objective of the present invention is to provide to an indoor shoe with an illumination capability, and, more particularly, to an indoor shoe with an illumination capability to provide nighttime illumination

In order to achieve the above mentioned objective, the present invention provides an indoor shoe with an illumination capability, and the indoor shoe comprises a shoe body, a light source, a triggering device, and a battery. The triggering device is electrically connected to the battery and the light source, and the triggering device is a pressure sensitive triggering device; wherein when a user steps on the bottom portion, the triggering device switches on the light source. The trigger device is a delayed triggering device; wherein when the user stops activating the triggering device, the light source remains activated for at least 1 second.

When the user gets out of bed at night, the triggering device may be immediately activated by the user's foot stepping onto the shoe body to turn on the light source; as the user walks, the delay built into the triggering device keeps the light source on to provide light in the direction in which the user is walking. When the user gets into bed, after the delay time has elapsed (such as one second or more), the triggering device automatically shuts off the light source to save power. The shoe further comprises a manual switch; therefore, in daytime the user can turn off the battery to save power.

Other objects, advantages, and novel features of the invention will become more apparent from the following detailed description when taken in conjunction with the accompanying drawings.

### BRIEF DESCRIPTION OF THE DRAWINGS

FIG. 1 is a schematic drawing of an indoor shoe with an illumination capability in a first embodiment according to the present invention.

FIG. 2 is a function block drawing of an embodiment according to the present invention.

FIG. 2a is a circuit schematic of the embodiment according to the present invention.

FIG. 3 is a schematic drawing of an indoor shoe with an illumination capability according to a second embodiment of the present invention.

### DETAILED DESCRIPTION OF THE PREFERRED EMBODIMENT

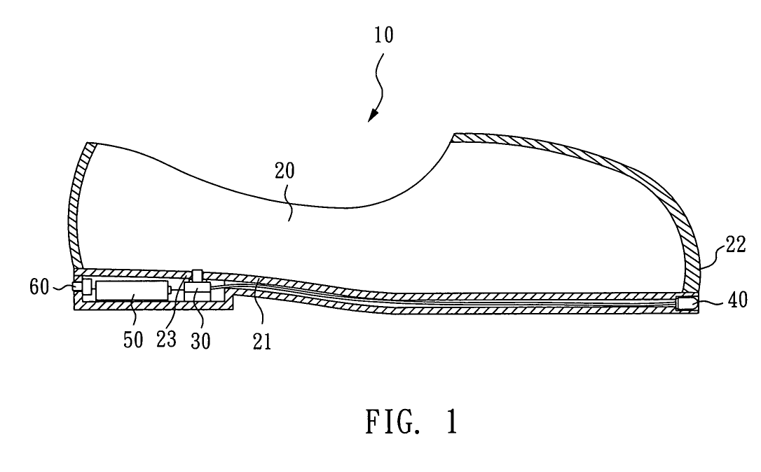

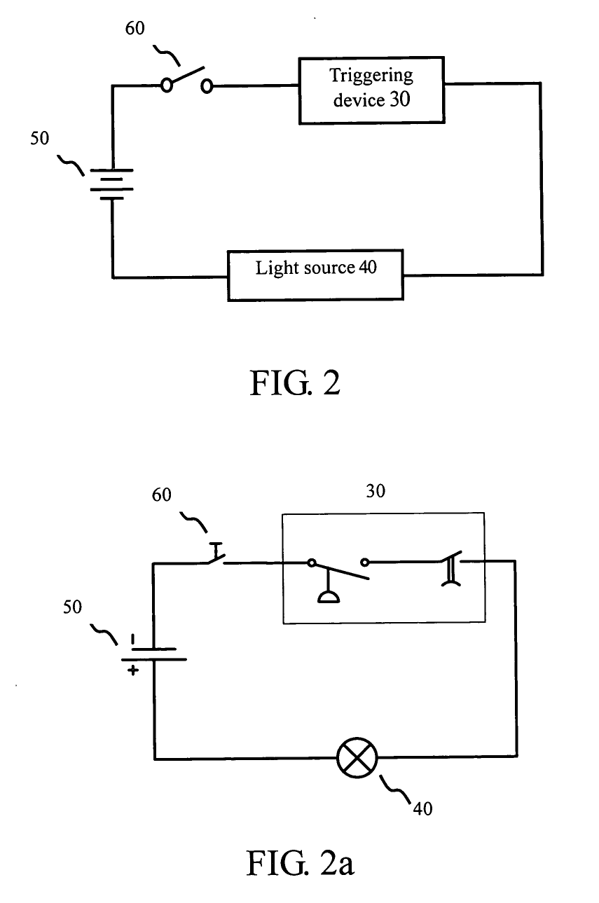

Please refer to FIG. 1, FIG. 2 and FIG. 2a. FIG. 1 is a schematic drawing of an indoor shoe with illumination capabilities according to a first embodiment of the present invention. FIG. 2 is a function block drawing of an embodiment according to the present invention. FIG. 2a is a circuit schematic of an embodiment according to the present invention.

An indoor shoe 10 with illumination capabilities comprises a shoe body 20, a light source 40, a triggering device 30, a battery 50 and a manual switch 60.

In this embodiment, the light source 40 (such as an LED) is disposed at a front end 22 of the shoe body 20, and the trigger device 30 is disposed at a bottom portion 21 of a back end of the shoe body 20 and used or controlling the light source 40. The battery 50 is disposed in the shoe body 20 and electrically connected to the triggering device 30, the light source 40 and the manual switch 60.

In this embodiment, the triggering device 30 is a pressure sensitive triggering device; when the user's sole steps upon the bottom portion 21, the resultant pressure causes the triggering device 30 to turn on the light source 40. The triggering device 30 may have a time-delay function; for example, the triggering device 30 may keep the light source 40 turned on for at least one second. When the user gets out of bed at night, the triggering device 30 may be immediately activated by the user's foot stepping onto the shoe body 20 to turn on the light source 40; as the user walks, the delay built into the triggering device 30 keeps the light source 30 on to provide light in the direction in which the user is walking. When the user gets into bed, after the delay time has elapsed (such as one second or more), the triggering device 30 automatically shuts off the light source 40 to save power.

In this embodiment, the triggering device 30 further comprises a manual switch 60; therefore, in daytime the user can turn off the triggering device 30 to save power.

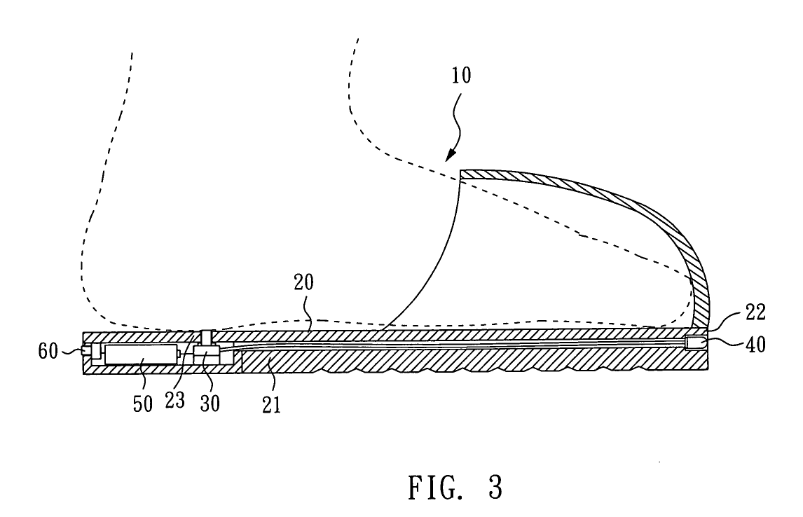

Please refer to FIG. 3 for a second embodiment of the present invention; a difference from the first embodiment is that the shoe body 20 is in the shape of an indoor slipper.

Although the present invention has been explained in relation to its preferred embodiment, it is to be understood that many other possible modifications and variations can be made without departing from the spirit and scope of the invention as hereinafter claimed. For example, the triggering device may be some other type of suitable triggering device, such as a light sensor (e.g., an infrared light detector) that is capable of detecting whether the user has put on the shoe.

What is claimed is:

1. An indoor shoe with an illumination capability comprising:
a shoe body having a bottom portion and a front end;
a light source disposed at the front end of the shoe body;
a triggering device disposed on the bottom portion of the shoe body for controlling the light source; and
a battery disposed in the shoe body and electrically connected to the triggering device and the light source.

2. The indoor shoe as claimed in claim 1, wherein the triggering device is a pressure sensitive triggering device; wherein when a user steps on the bottom portion, the triggering device switches on the light source.

3. The indoor shoe as claimed in claim 2, wherein the triggering device is a delayed triggering device; wherein when the user stops activating the triggering device, the light source remains activated for at least 1 second.

4. The indoor shoe as claimed in claim 1 further comprising a manual switch for controlling the battery.

5. The indoor shoe as claimed in claim 3 further comprising a manual switch for controlling the battery.

6. The indoor shoe as claimed in claim 1, wherein the shoe body is a slipper.

7. The indoor shoe as claimed in claim 3, wherein the shoe body is a slipper.

8. The indoor shoe as claimed in claim 5, wherein the shoe body is a slipper.
